(19) United States
(12) Patent Application Publication
(10) Pub. No.: US 2026/0070490 A1
(43) Pub. Date: Mar. 12, 2026

(54) INSULATED STORAGE BIN FOR VEHICLE INSTRUMENT PANEL

(71) Applicant: Ford Global Technologies, LLC, Dearborn, MI (US)

(72) Inventors: Diego Santillan Gutierrez, Tizayuca (MX); Jeff Christ, Milford, MI (US); Boris Schwarzer, Huntington Woods, MI (US); Alejandro Rosas Vazquez, Mexico City (MX)

(73) Assignee: Ford Global Technologies, LLC, Dearborn, MI (US)

(21) Appl. No.: 18/830,724

(22) Filed: Sep. 11, 2024

(51) Int. Cl. B60R 7/06

(52) U.S. Cl. CPC B60R 7/06

(57) ABSTRACT

A vehicle storage bin assembly has a tray configured to be located on an instrument panel in a vehicle. The tray defines an open receptacle and a thermal insulated storage bin configured to be stored in the tray. The storage bin has a housing base having an outer shape configured to be received in the open receptacle of the tray. The bin further has a lid coupled to the housing base via at least one pivot arm and configured to move between an open position and a closed position. The lid comprises a thermal insulation.

### FIELD OF THE DISCLOSURE

The present disclosure generally relates to vehicle storage compartments, and more particularly relates to a thermal insulated storage compartment configured to be located on the instrument panel of a motor vehicle.

### BACKGROUND OF THE DISCLOSURE

Motor vehicles are commonly equipped with storage compartments within the passenger compartment of the vehicle. For example, a center console storage compartment and a glove box in front of a front passenger seat are typically provided on motor vehicles and are generally fixedly built into the passenger compartment in the motor vehicle. In addition, vehicles are often equipped with one or more open trays configured to support items. It may be desirable to provide for a removable storage compartment with thermal efficiencies on a vehicle that allows for concealed storage and is easy to access.

### SUMMARY OF THE DISCLOSURE

According to a first aspect of the present disclosure, a vehicle storage bin assembly has a tray configured to be located on an instrument panel in a vehicle. The tray defines an open receptacle and a thermal insulated storage bin configured to be stored in the tray. The storage bin has a housing base having an outer shape configured to be received in the open receptacle of the tray. The bin further has a lid coupled to the housing base via at least one pivot arm and configured to move between an open position and a closed position. The lid comprises a thermal insulation.

Embodiments of the first aspect of the present disclosure can include any one or a combination of the following features:
the thermal insulation storage bin is removably connected to the tray;
one or more fasteners for fastening the storage bin on the tray, wherein the one or more fasteners allow the storage bin to be removed from the tray;
at least one pivot arm comprises a first pivot arm spaced from a second pivot arm, wherein the first and second pivot arms pivot about a common axis;
at least one of the first and second pivot arms comprises a plurality of teeth operatively coupled to a gear;
the gear comprises a gear damper for dampening the movement of the lid;
each of the first and second pivot arms further comprises a torsion spring biasing the lid to the open position;
the thermal insulation comprises an insulation mat;
the housing base further comprises at least one opening for receiving one or more electrical cords;
a latch mechanism; and
a release button for releasing the latch mechanism to allow the lid to move to the open position.

According to a second aspect of the present disclosure, a vehicle includes an instrument panel, a tray provided in the instrument panel, and a vehicle storage bin assembly. The vehicle storage bin assembly has a tray configured to be located on an instrument panel in a vehicle. The tray defines a shaped opening and a thermal insulated storage bin configured to be stored in the tray. The storage bin has a housing base having an outer shape configured to be received in the shaped portion of the tray. The bin further has a lid coupled to the housing base via at least one pivot arm and configured to move between an open position and a closed position. The lid comprises a thermal insulation.

Embodiments of the second aspect of the present disclosure can include any one or a combination of the following features:
the thermal insulation storage bin is removably connected to the tray;
one or more fasteners for fastening the storage bin on the tray, wherein the one or more fasteners allow the storage bin to be removed from the tray;
at least one pivot arm comprises a first pivot arm spaced from a second pivot arm, wherein the first and second pivot arms pivot about a common axis;
at least one of the first and second pivot arms comprises a plurality of teeth operatively coupled to a gear;
the gear comprises a gear damper for dampening the opening and closing of the lid;
each of the first and second pivot arms further comprises a torsion spring biasing the lid to the open position;
the thermal insulation comprises an insulation mat;
the housing base further comprises at least one opening for receiving one or more electrical cords;
a latch mechanism; and
a release button for releasing the latch mechanism to allow the cover to move to the open position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper perspective view of a front portion of a passenger compartment of a motor vehicle equipped with a storage bin assembly, according to one embodiment;

FIG. 2 is an enlarged perspective view of the storage bin assembly shown in FIG. 1 installed within an open tray provided in an instrument panel;

FIG. 3 is an upper perspective view of the storage bin assembly with the storage bin lid in the open position;

FIG. 4 is an upper perspective view of the storage bin assembly with the storage bin shown removed from the tray in the instrument panel;

FIG. 5 is a lower perspective view of the storage bin shown removed from the open tray;

FIG. 6 is a cross-sectional view taken through line VI-VI of FIG. 2 further illustrating one of the hinge assemblies with the lid in the closed position;

FIG. 6A is a cross-sectional view taken through line VI-VI of FIG. 2 with the lid in the open position;

FIG. 7 is a partial cutaway view of Section VII showing the hinge assembly;

FIG. 7A is an end view of the hinge assembly shown in FIG. 7 with the lid in the closed position;

FIG. 7B is an end view of the hinge assembly shown in FIG. 7 with the lid in the open position;

FIG. 8 is a cross-sectional view taken through line VII-VIII of FIG. 2 of the storage bin container illustrating the latch assembly in an unlatched position; and

FIG. 8A is a cross-sectional view taken through line VIII-VIII of FIG. 2 of the latch assembly in the latched position.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

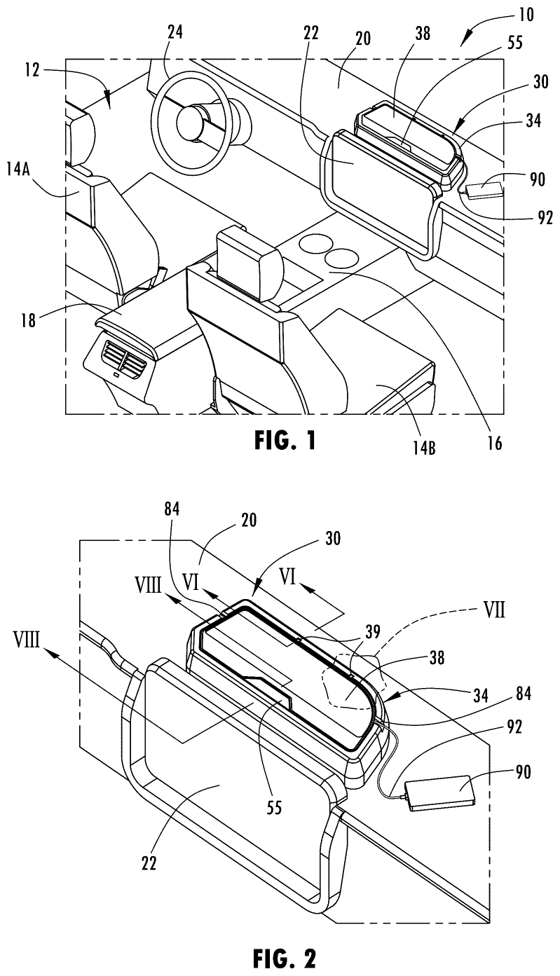

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle storage bin assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises. a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about. ” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a motor vehicle 10 is generally illustrated configured with passenger seating for transporting one or more passengers including a driver of the motor vehicle 10 and is further configured for transporting one or more items in an insulated storage bin assembly 30 onboard the motor vehicle 10. The motor vehicle 10 generally has a vehicle body that defines a cabin interior 12 which may also be referred to as a passenger compartment. The cabin interior 12 may contain various features and trim components. The cabin interior 12 is shown having an arrangement of front row passenger seats including a first seat assembly 14A configured to seat a driver and a second seat assembly 14B configured to seat a passenger. The first and second seat assemblies 14A and 14B may be configured as captain's seats, for example, laterally spaced apart separated by a space which includes a center console 16 that includes a pivotable lid 18 covering a center console storage compartment, wherein the lid 18 in the closed position may also serve as an armrest for passengers seated in the first and second seating assemblies 14A and 14B. The motor vehicle 10 illustrated in the example may include additional seating such as a second row of seating or further rearward rows of seating as is common in large SUVs, vans or buses. It should be appreciated that the motor vehicle 10 may be a motor vehicle such as a wheeled car, truck, SUV, van or bus, for example, or an airplane, train, boat or other vehicle capable of transporting one or more passengers or items.

The motor vehicle 10 is equipped with an instrument panel 20, also referred to as a dashboard, which generally extends the width of the cabin interior 12 of the motor vehicle 10 generally forward of the front row seating 14A and 14B. A steering wheel 24 is shown generally extending from the instrument panel 20 generally forward of the first seating assembly 14A to enable a driver of the vehicle to steer the motor vehicle 10. Disposed centrally on the rear wall of the instrument panel 20 is a display device 22 which may include a touch screen display that may provide user display outputs and allow user input, for example.

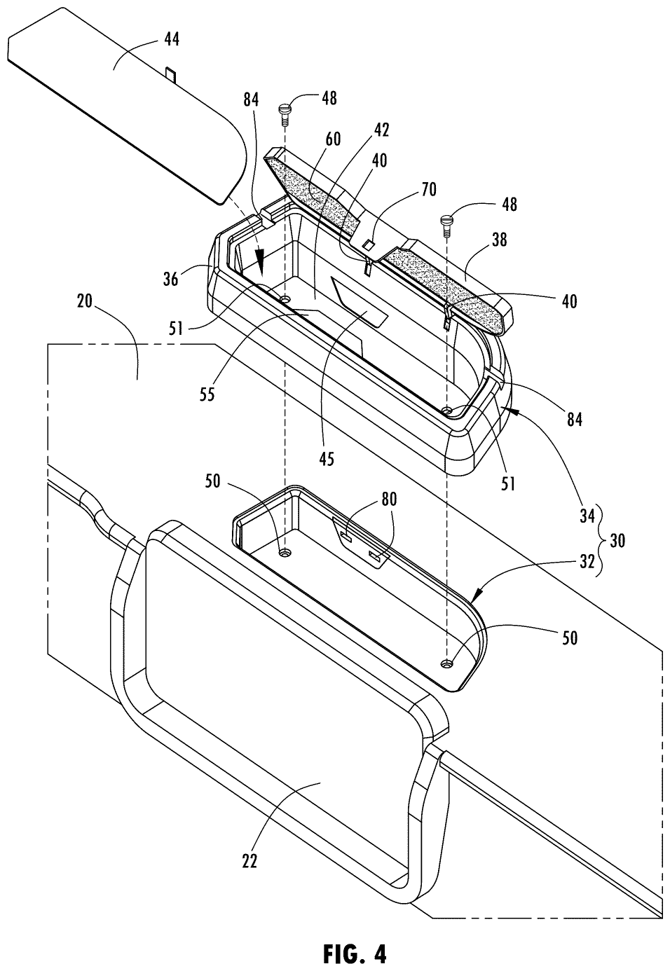

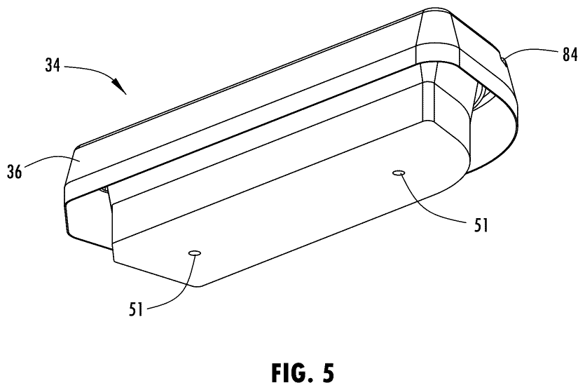

Formed on the top surface within a central portion of the instrument panel 20 generally midway between the left and right sides and vehicle forward of the display device 22 is an open tray 32. The open tray 32 is generally illustrated in FIG. 4 and defines an open receptacle. The open tray 32 is configured as a recess having upstanding walls that extend upwards from and a bottom flat surface that generally define the shape and size of the open tray 32. The open tray 32 shown has a generally rectangular shape with rounded corners according to one example. It should be appreciated that items may be disposed in the open tray 32 when the open tray 32 is exposed.

The open tray 32 is configured to receive a removable thermal insulated storage bin 34 which is part of a vehicle storage bin assembly 30. The thermal insulated storage bin 34 is configured to receive one or more items, such as cargo items, and hold such items for storage. The thermal insulated storage bin 34 has a housing base 36 which has an outer shape and size configured to conform to and fit within the open tray 32. The housing 36 has upstanding side walls and a bottom surface 42 which define the space of the compartment for holding one or more items. The housing 36 may be removably connected to the instrument panel 20 via a pair of fasteners 48 which may extend through openings 51 and engage threaded openings 50 in the instrument panel 20. It should be appreciated that the fasteners 48 may include a pair of screws or bolts, for example, which may be removed easily with a tool such as a screwdriver by a user to remove the storage bin 34 and to reinstall the storage bin 34. Once the fasteners 48 are threadedly engaged within threaded openings 50 in the bottom of the tray 32, a floor covering 44 may be installed on top of the bottom surface 42 to cover the fasteners 48.

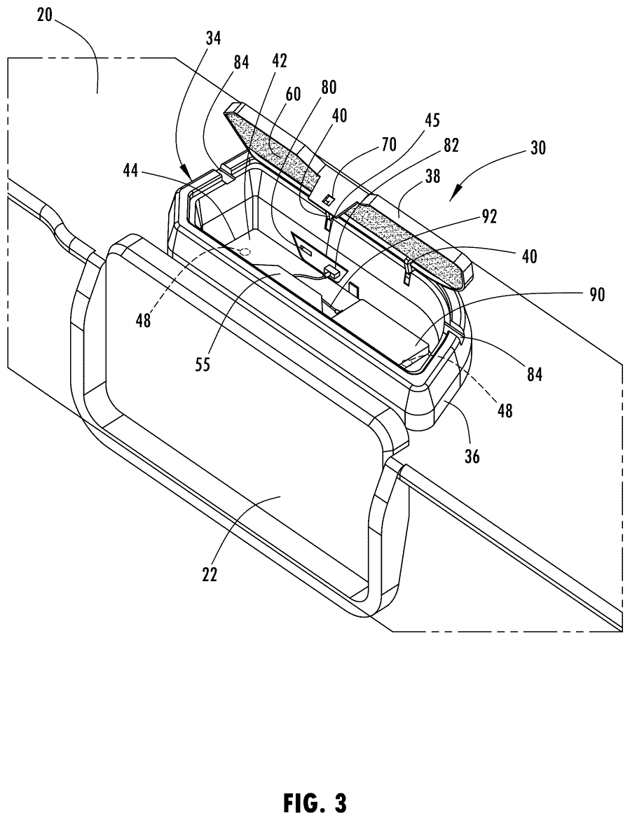

The insulated storage bin 34 has an insulated lid 38 hingedly connected on a front edge to the housing base 36. The hinged connection of the lid 38 onto the housing base 36 includes a pair of pivot mechanisms 40 extending through slots 39 in the base which operate as hinge assemblies to allow the lid 38 to pivot between a closed position shown in FIG. 2 and an open position shown in FIG. 3. The storage bin 34 is a thermal insulated storage bin that includes thermal insulation 60 provided in the lid 38 such as on the underside as shown in FIGS. 3 and 4. The thermal insulation 60 may include an insulation mat such as a heat insulator polycrystalline mat. One example of a heat insulator polycrystalline mat is commercially available from 3M, commercially available as 3M Mat Mount 1535 MT. It should be understood that the thermal insulation may include one or more layers of insulation that is configured to provide thermal isolation to substantially reduce thermal energy transfer through the thermal insulation 60 and hence the lid 38. As such, the storage bin 34 is thermally insulated which advantageously allows for the storage of items such as electronic devices and other heat sensitive items to be securely held on the instrument panel 20 in a manner that prevents or reduces thermal energy from rapidly elevating the temperature of the contents within the storage bin 34.

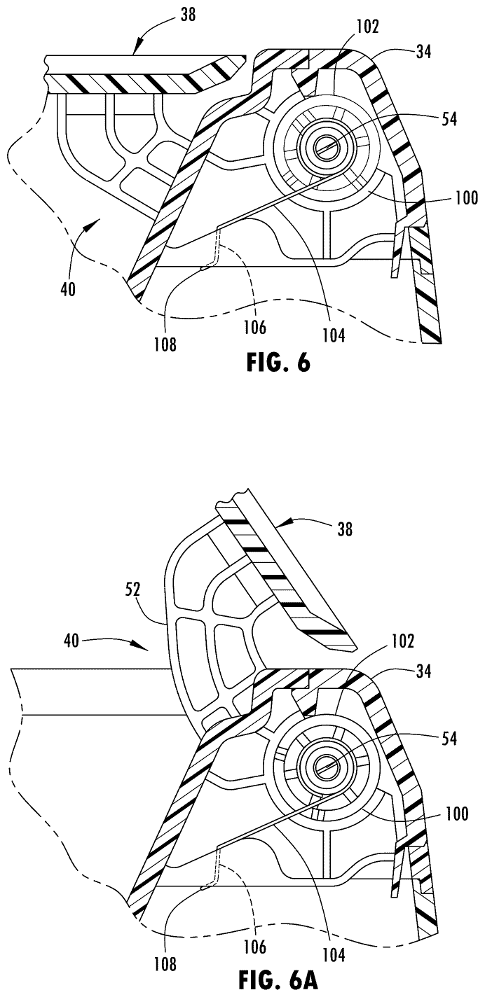

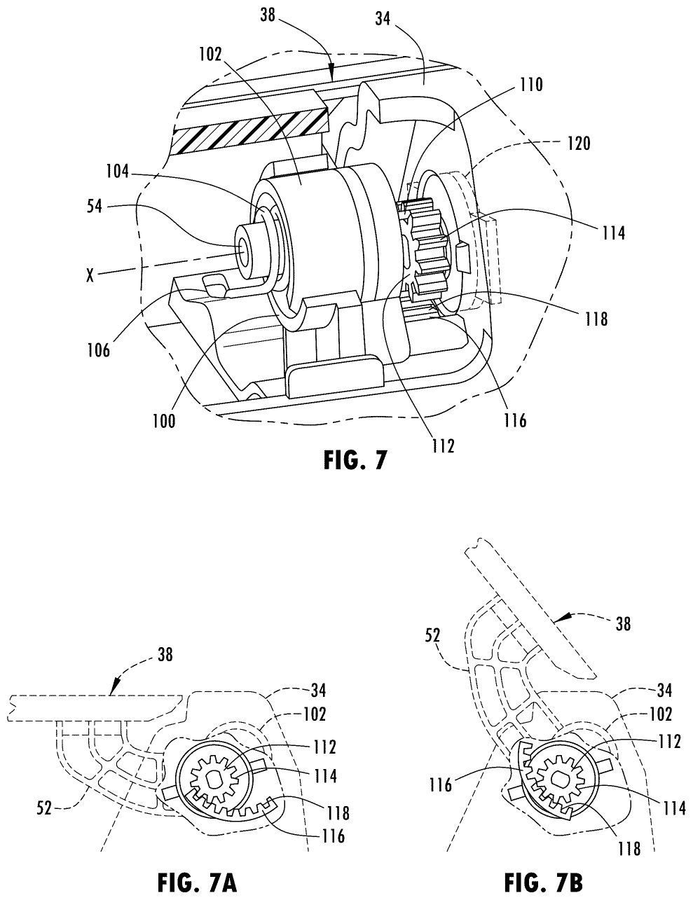

The pair of pivot mechanisms 40 are configured to rotate the lid 38 between the closed position shown in FIG. 2 and the open position shown in FIG. 3. The pivot mechanisms 40 may each be configured as illustrated in FIGS. 6-7B. As seen in FIG. 6, the pivot mechanism 40 includes a connector arm 52 connected between the lid 38 and a pivot shaft 54 which allows rotation or pivoting about an X-axis. The pivot arm 52 has a C-shape friction engaged connector 100 at one end configured to snap in and engage a cylinder 102 that surrounds the pivot shaft 54. A torsion spring 104 engages the housing base 36 through an opening 106 and a damper gear 112 via an opposite end 110 of torsion spring 104. The connector arm 52 further includes an arcuate toothed surface 116 having teeth 118 configured to engage teeth 114 on the damper gear 112. Accordingly, as the lid 38 pivots between the open and closed positions, the arcuate toothed surface 116 is rotated to cause rotation of the damper gear 112. The damper gear 112 in turn is coupled to a viscous damper 120 which thereby dampens the movement of the lid 38 between the open and closed positions.

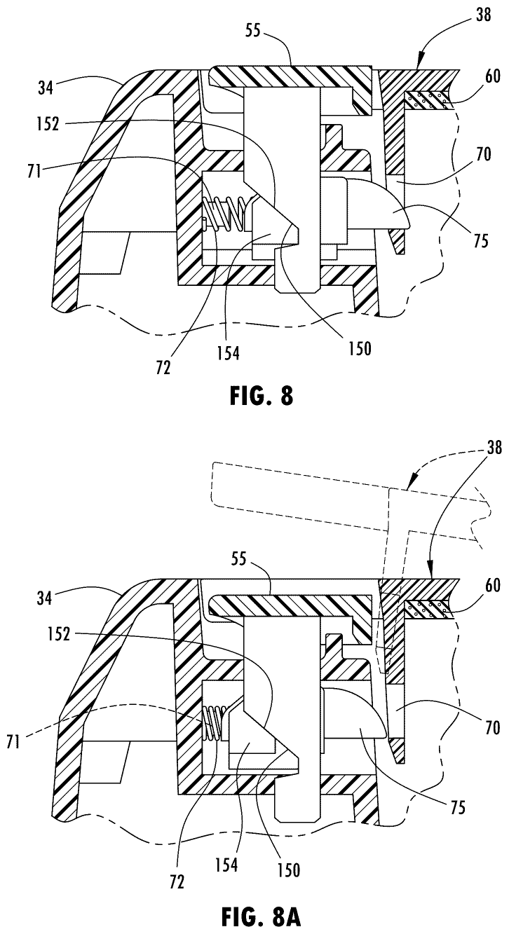

The lid 38 includes a latch receiving opening 70 for engaging a tooth 75 of a latch mechanism 55 on the housing base 34 to latch the lid 38 in the closed position as seen in FIG. 8. The latch mechanism 55 includes a push button actuator having an angled surface 150 that slideably engages an angled surface 152 on a slider bar 154. The slider bar 154 moves laterally against a bias spring 72 which engages pin 71. The slider bar 154 has the tooth 75 on the outer end thereof for engaging the opening 70 in the lid 38 when the lid 38 is in the closed position.

When a user depresses the push button mechanism 55 downward, angled surface 150 forces the slider mechanism to move the tooth 75 to the left against the spring to the open position outside of opening 70 to thereby release the lid 38 from engagement with the slider bar 154 as seen in FIG. 8A. Once the lid 38 is released from the latch mechanism 55, the torsion spring 104 biases the lid 38 to move towards the open position. When this occurs, the viscous damper 120 dampers the motion to allow the lid 38 to open more slowly and more easily.

The storage bin 34 is further equipped with an opening 45 within the housing base 36 as illustrated in FIGS. 3 and 4 which exposes one or more electronic device connecting ports. In the example shown, a pair of USB ports 80 are shown exposed within the opening 45 to allow one or more connectors on one or more electronic devices 90 to be connected to power the device and/or to provide data communication with the motor vehicle 10 and any accessories associated with the motor vehicle 10. In addition, the housing base 36 has a pair of slots 84 provided on one or more walls to enable a power and/or communication cord connecting a device to a port to extend through the housing base 36.

Accordingly, the vehicle storage bin assembly 30 advantageously provides for a thermal insulated storage bin 34 that may be removeably connected onto an open tray 32 located on the top surface of the instrument panel 20 on a motor vehicle 10. The removable thermal insulated storage bin 34 advantageously provides thermal insulation to provide a more stable temperature and may be readily removed from the open tray 32 by a user.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle storage bin assembly, comprising:
a tray configured to be located on an instrument panel in a vehicle, the tray defining an open receptacle; and
a thermal insulated storage bin configured to be stored in the tray, wherein the storage bin has a housing base having an outer shape configured to be received in the open receptacle of the tray, the bin further comprising a lid coupled to the housing base via at least one pivot arm and configured to move between an open position and a closed position, wherein the lid comprises a thermal insulation.

2. The vehicle storage bin assembly of claim 1, wherein the thermal insulation storage bin is removably connected to the tray.

3. The vehicle storage bin assembly of claim 2, further comprising one or more fasteners for fastening the storage bin on the tray, wherein the one or more fasteners allow the storage bin to be removed from the tray.

4. The vehicle storage bin assembly of claim 1, wherein the at least one pivot arm comprises a first pivot arm spaced from a second pivot arm, wherein the first and second pivot arms pivot about a common axis.

5. The vehicle storage bin assembly of claim 4, wherein at least one of the first and second pivot arms comprises a plurality of teeth operatively coupled to a gear.

6. The vehicle storage bin assembly of claim 5, wherein the gear comprises a gear damper for dampening the movement of the lid.

7. The vehicle storage bin assembly of claim 6, wherein each of the first and second pivot arms further comprises a torsion spring biasing the lid to the open position.

8. The vehicle storage bin assembly of claim 1, wherein the thermal insulation comprises an insulation mat.

9. The vehicle storage bin assembly of claim 1, wherein the housing base further comprises at least one opening for receiving one or more electrical cords.

10. The vehicle storage bin assembly of claim 1, further comprising:
a latch mechanism; and
a release button for releasing the latch mechanism to allow the lid to move to the open position.

11. A vehicle comprising:
an instrument panel;
a tray provided in the instrument panel; and
a vehicle storage bin assembly comprising:
a tray configured to be located on an instrument panel in a vehicle, the tray defining a shaped opening; and
a thermal insulated storage bin configured to be stored in the tray, wherein the storage bin has a housing base having an outer shape configured to be received in the shaped portion of the tray, the bin further comprising a lid coupled to the housing base via at least one pivot arm and configured to move between an open position and a closed position, wherein the lid comprises a thermal insulation.

12. The vehicle of claim 11, wherein the thermal insulation storage bin is removably connected to the tray.

13. The vehicle of claim 12, further comprising one or more fasteners for fastening the storage bin on the tray, wherein the one or more fasteners allow the storage bin to be removed from the tray.

14. The vehicle of claim 11, the at least one pivot arm comprises a first pivot arm spaced from a second pivot arm, wherein the first and second pivot arms pivot about a common axis.

15. The vehicle of claim 14, wherein at least one of the first and second pivot arms comprises a plurality of teeth operatively coupled to a gear.

16. The vehicle of claim 15, wherein the gear comprises a gear damper for dampening the opening and closing of the lid.

17. The vehicle of claim 16, wherein each of the first and second pivot arms further comprises a torsion spring biasing the lid to the open position.

18. The vehicle of claim 11, wherein the thermal insulation comprises an insulation mat.

19. The vehicle of claim 11, wherein the housing base further comprises at least one opening for receiving one or more electrical cords.

20. The vehicle of claim 11, further comprising:
a latch mechanism; and
a release button for releasing the latch mechanism to allow the cover to move to the open position.
